(19) United States
(12) Patent Application Publication
(10) Pub. No.: US 2011/0183215 A1
(43) Pub. Date: Jul. 28, 2011

(54) Layered Electrode For An Electrochemical Cell

(75) Inventors: Amy C. Marschilok, Clarence, NY (US); Randolph A. Leising, Williamsville, NY (US); Esther S. Takeuchi, East Amherst, NY (US)

(73) Assignee: Greatbatch Ltd., Clarence, NY (US)

(21) Appl. No.: 11/695,253

(22) Filed: Apr. 2, 2007

Related U.S. Application Data
(60) Provisional application No. 60/790,750, filed on Apr. 10, 2006.

(51) Int. Cl. H01M 10/02; H01M 4/64; H01M 4/54

(52) U.S. Cl. 429/338; 429/211; 429/337; 429/343; 429/341; 429/342; 429/339; 429/340; 429/336; 429/188; 429/199

(57) ABSTRACT

A new cathode design is provided comprising a cathode active material mixed with a binder and a conductive diluent in at least two differing formulations. Each of the formulations exists as a distinct cathode layer. After each layer is pressed or sheeted individually, a first one of the layers is contacted to a current collector. The other layer is then contacted to the opposite side of the layer contacting the current collector. Therefore, by using electrodes comprised of layers, where each layer is optimized for a desired characteristic (i.e. high capacity, high power, high stability), the resulting battery will display improved function over a wide range of applications. Such an exemplary cathode is comprised of: SVO (100−x %)/SVO (100−y %)/current collector/SVO (100−y %)/SVO (100−x %), wherein x and y are different and represent percentages of non-active materials.

### CROSS REFERENCE TO RELATED APPLICATION

The present application claims priority to U.S. provisional application Ser. No. 60/790,750, filed Apr. 10, 2006.

### BACKGROUND OF THE INVENTION

This invention relates to the conversion of chemical energy to electrical energy. In particular, the present invention related to a new layered electrode design having a first cathode active formulation formed as a distinct layer in contact with a second cathode active formulation. The second cathode active formulation is in contact with a current collector screen. The active material of the first and second layers is the same. The present cathode design is useful for high discharge rate applications, such as experienced by cells powering an implantable medical device.

### SUMMARY OF THE INVENTION

Silver vanadium oxide (SVO) is known to have high power capability. In conventional SVO cells, the cathode active material is always mixed with a few weight percent of carbonaceous additives along with a few weight percent of binder materials. Without the use of a conductive additive, such as carbon black, graphite, etc., in an SVO cathode active formulation, its power capability at a low percent of discharge or small depth of discharge (DoD) is significantly worse than if the conductive additive were present. However, a drawback is that the conductive additive decreases the practical density of the cathode. In other words, the gram amount of cathode active material per unit volume is lower than that of the SVO active material without the non-active carbonaceous additives.

It is theorized that in a lithium/SVO cell, vanadium compounds become soluble in the cell electrolyte from the cathode and are subsequently deposited onto the lithium anode surface. The resulting anode surface passivation film is electrically insulating, which leads to cell polarization and voltage delay. According to the present invention, SVO material without any conductive or binder additives, or with a lesser percentage of additives, is in direct contact with the current collector. A second SVO material formulation having a greater percentage of binder and conductive additives than that of the first formulation contacts the first formulation opposite the current collector. As a result, lithium cells with cathodes of this configuration have the same or higher discharge rate capability as that of conventional Li/SVO cells. At the same time, the present cell exhibits equal or higher capacity than that of a conventional cell due to the greater energy density contributed by the higher percentage active material contacting the current collector and being “shielded” from the anode by the second active formulation portion. This shielding effect is believed to help prevent vanadium dissolution into the electrolyte and subsequent deposition on the lithium anode, as discussed above. Higher volumetric efficiency is also realized with this cathode design.

Accordingly, one object of the present invention is to improve the performance of lithium electrochemical cells by providing a new concept in electrode design. Further objects of this invention include providing a cell design for improving the capacity and utilization or volumetric efficiency of lithium-containing cells.

These and other objects of the present invention will become increasingly more apparent to those skilled in the art by a reading of the following detailed description.

### DETAILED DESCRIPTION OF THE INVENTION

In describing the present invention, the following terms are used.

The term percent of depth-of-discharge (DoD) is defined as the ratio of delivered capacity to theoretical capacity times 100.

The term “pulse” means a short burst of electrical current of significantly greater amplitude than that of a pre-pulse current or open circuit voltage immediately prior to the pulse. A pulse train consists of at least one pulse of electrical current. The pulse is designed to deliver energy, power or current. If the pulse train consists of more than one pulse, they are delivered in relatively short succession with or without open circuit rest between the pulses.

In performing accelerated discharge testing of a cell, an exemplary pulse train may consist of one to four 5- to 20-second pulses (23.2 mA/cm²) with about a 10 to 30 second rest, preferably about 15 second rest, between each pulse. A typically used range of current densities for cells powering implantable medical devices is from about 15 mA/cm² to about 50 mA/cm², and more preferably from about 18 mA/cm² to about 35 mA/cm². Typically, a 10-second pulse is suitable for medical implantable applications. However, it could be significantly shorter or longer depending on the specific cell design and chemistry and the associated device energy requirements. Current densities are based on square centimeters of the cathode electrode.

An electrochemical cell that possesses sufficient energy density and discharge capacity required to meet the vigorous requirements of implantable medical devices comprises an anode of lithium. An alternate anode comprises a lithium alloy such as a lithium-aluminum alloy. The greater the amounts of aluminum present by weight in the alloy, however, the lower the energy density of the cell.

The form of the anode may vary, but preferably it is a thin metal sheet or foil of the lithium metal, pressed or rolled on a metallic anode current collector, i.e., preferably comprising titanium, titanium alloy or nickel. Copper, tungsten and tantalum are also suitable materials for the anode current collector. The anode current collector has an extended tab or lead contacted by a weld to a cell case of conductive metal in a case-negative electrical configuration. Alternatively, the anode may be formed in some other geometry, such as a bobbin shape, cylinder or pellet, to allow for a low surface cell design.

The electrochemical cell of the present invention is of either a primary chemistry or a secondary, rechargeable chemistry. For both the primary and secondary types, the cell comprises an anode of lithium. An alternate anode comprises a lithium alloy for example, Li—Si, Li—Al, Li—B, Li—Mg and Li—Si—B alloys and intermetallic compounds. The greater the amounts of the secondary material present by weight in the alloy, however, the lower the energy density of the cell.

For a primary cell, the anode is a thin metal sheet or foil of the lithium material, pressed or rolled on a metallic anode current collector, i.e., preferably comprising titanium, titanium alloy or nickel. Copper, tungsten and tantalum are also suitable materials for the anode current collector. The anode current collector has an extended tab or lead contacted by a weld to a cell case of conductive metal in a case-negative electrical configuration. Alternatively, the anode may be formed in some other geometry, such as a bobbin shape, cylinder or pellet, to allow for a low surface cell design.

In secondary electrochemical systems, the anode or negative electrode comprises an anode material capable of intercalating and de-intercalating the anode active material, such as the preferred alkali metal lithium. A carbonaceous negative electrode comprising any of the various forms of carbon (e.g., coke, graphite, acetylene black, carbon black, glassy carbon, etc.) which are capable of reversibly retaining the lithium species is preferred for the anode material. A meso-carbon micro bead (MCMB) graphite material is particularly preferred due to its relatively high lithium-retention capacity and rapid charge/discharge rates.

A typical negative electrode for a secondary cell is fabricated by mixing about 90 to 97 weight percent MCMB with about 3 to 10 weight percent of a binder material, which is preferably a fluoro-resin powder such as polytetrafluoroethylene (PTFE), polyvinylidene fluoride (PVDF), polyethylenetetrafluoroethylene (ETFE), polyamides, polyimides, and mixtures thereof. This negative electrode admixture is provided on a current collector such as of a nickel, stainless steel, or copper foil or screen by casting, pressing, rolling or otherwise contacting the admixture thereto.

In either the primary cell or the secondary cell, the reaction at the positive electrode involves conversion of ions which migrate from the negative electrode to the positive electrode into atomic or molecular forms. For a primary cell, the cathode active material comprises a carbonaceous chemistry or at least a first transition metal chalcogenide constituent which may be a metal, a metal oxide, or a mixed metal oxide comprising at least a first and a second metals or their oxides and possibly a third metal or metal oxide, or a mixture of a first and a second metals or their metal oxides incorporated in the matrix of a host metal oxide. The cathode active material may also comprise a metal sulfide.

Carbonaceous active materials are preferably prepared from carbon and fluorine, which includes graphitic and nongraphitic forms of carbon, such as coke, charcoal or activated carbon. Fluorinated carbon is represented by the formula (CFₓ)ₙ wherein x varies between about 0.1 to 1.9 and preferably between about 0.5 and 1.2, and (C₂F) n wherein n refers to the number of monomer units which can vary widely.

The metal oxide or the mixed metal oxide is produced by the chemical addition, reaction, or otherwise intimate contact of various metal oxides, metal sulfides and/or metal elements, preferably during thermal treatment, sol-gel formation, chemical vapor deposition or hydrothermal synthesis in mixed states. The active materials thereby produced contain metals, oxides and sulfides of Groups IB, IIB, IIIB, IVB, VB, VIIB, VIIB and VIII, which include the noble metals and/or other oxide and sulfide compounds. A preferred cathode active material is a reaction product of at least silver and vanadium.

One preferred mixed metal oxide is a transition metal oxide having the general formula SMₓV₂O_{y} where SM is a metal selected from Groups IB to VIIB and VIII of the Periodic Table of Elements, wherein x is about 0.30 to 2.0 and y is about 4.5 to 6.0 in the general formula. By way of illustration, and in no way intended to be limiting, one exemplary cathode active material comprises silver vanadium oxide having the general formula AgₓV₂O_{y} in any one of its many phases, i.e., β-phase silver vanadium oxide having in the general formula x=0.35 and y=5.8, γ-phase silver vanadium oxide having in the general formula x=0.80 and y=5.40 and ε-phase silver vanadium oxide having in the general formula x=1.0 and y=5.5, and combination and mixtures of phases thereof. For a more detailed description of such cathode active materials reference is made to U.S. Pat. No. 4,310,609 to Liang et al. This patent is assigned to the assignee of the present invention and incorporated herein by reference.

Another preferred composite transition metal oxide cathode material includes V₂O_{z} wherein z≦5 combined with Ag₂O having silver in either the silver(II), silver(I) or silver(0) oxidation state and CuO with copper in either the copper(II), copper(I) or copper(0) oxidation state to provide the mixed metal oxide having the general formula CuₓAg_{y}V₂O_{z}, (CSVO). Thus, the composite cathode active material may be described as a metal oxide-metal oxide-metal oxide, a metal-metal oxide-metal oxide, or a metal-metal-metal oxide and the range of material compositions found for CuₓAg_{y}V₂O_{z} is preferably about 0.01≦z≦6.5. Typical forms of CSVO are Cu_{0.16}Ag_{0.67}V₂O_{z} with z being about 5.5 and Cu_{0.5}Ag_{0.5}V₂O_{z} with z being about 5.75. The oxygen content is designated by z since the exact stoichiometric proportion of oxygen in CSVO can vary depending on whether the cathode material is prepared in an oxidizing atmosphere such as air or oxygen, or in an inert atmosphere such as argon, nitrogen and helium. For a more detailed description of this cathode active material reference is made to U.S. Pat. Nos. 5,472,810 and 5,516,340, both to Takeuchi et al. These patents are assigned to the assignee of the present invention and incorporated herein by reference.

In addition to the previously described fluorinated carbon, silver vanadium oxide and copper silver vanadium oxide, Ag₂O, Ag₂O₂, CuF₂, Ag₂CrO₄, MnO₂, V₂O₅, MnO₂, TiS₂, Cu₂S, FeS, FeS₂, copper oxide, copper vanadium oxide, and mixtures thereof are contemplated as useful active materials.

In secondary cells, the positive electrode preferably comprises a lithiated material that is stable in air and readily handled. Examples of such air-stable lithiated cathode active materials include oxides, sulfides, selenides, and tellurides of such metals as vanadium, titanium, chromium, copper, molybdenum, niobium, iron, nickel, cobalt, and manganese. The more preferred oxides include LiNiO₂, LiMn₂O₄, LiCoO₂, LiCo_{0.92}Sn_{0.08}O₂, and LiCo₁₋ₓNiₓO₂.

To charge such secondary cells, the lithium ion comprising the positive electrode is intercalated into the carbonaceous negative electrode by applying an externally generated electrical potential to the cell. The applied recharging electrical potential serves to draw lithium ions from the cathode active material, through the electrolyte and into the carbonaceous material of the negative electrode to saturate the carbon. The resulting LiₓC₆ negative electrode can have an x ranging between 0.1 and 1.0. The cell is then provided with an electrical potential and is discharged in a normal manner.

An alternate secondary cell construction comprises intercalating the carbonaceous material with the active lithium material before the negative electrode is incorporated into the cell. In this case, the positive electrode body can be solid and comprise, but not be limited to, such active materials as manganese dioxide, silver vanadium oxide, titanium disulfide, copper oxide, copper sulfide, iron sulfide, iron disulfide and fluorinated carbon. However, this approach is compromised by problems associated with handling lithiated carbon outside of the cell. Lithiated carbon tends to react when contacted by air or water.

The above described cathode active materials, whether of a primary or a secondary chemistry, are formed into an electrode for incorporation into an electrochemical cell by mixing one or more of them with a binder material. Suitable binders are powdered fluoro-polymers, for example powdered polytetrafluoroethylene or powdered polyvinylidene fluoride, or a poly(alkylene carbonate) having the general formula R—O—C(═O)—O with R=C1 to C5, preferably poly(ethylene carbonate) and poly(propylene carbonate). Suitable poly(aklylene carbonate) binders are commercially available from Empower Materials, Inc., Newark, Del. under the designations QPAC 25 and QPAC 40. If desired, the fluoro-polymer can be mixed with the poly(alkylene) carbonate as a binder mixture. In any event, the binder is present at about 1 to about 5 weight percent of the cathode mixture.

Up to about 10 weight percent of a conductive diluent is preferably added to the cathode mixture to improve conductivity. Suitable materials for this purpose include acetylene black, carbon black and/or graphite or a metallic powder such as powdered nickel, aluminum, titanium, and stainless steel. Further, if a poly(alkylene) carbonate is used as a binder, it may serve the dual purpose of the conductive diluent, or mean that less of the above described conductive materials are needed. This means that more active material can be used, which increased the volumetric efficiency of the cathode. The preferred cathode active mixture thus includes a powdered fluoro-polymer/poly(alkylene) carbonate binder present at about 1 to 5 weight percent, a conductive diluent present at about 1 to 5 weight percent and about 90 to 98 weight percent of the cathode active material.

According to the present invention, any one of the above cathode active materials, whether of a primary or a secondary cell, is mixed with a binder and a conductive diluent in at least two differing formulations. Each of the formulations exists as a distinct cathode layer. After each layer is pressed or sheeted individually, they are pressed together in the presence of a single current collector to form a layered electrode. Preferably, the first layer spaced from the anode is of a greater active material percentage than that of the second layer directly opposing the anode.

Suitable current collector selected from the group consisting of stainless steel, titanium, tantalum, platinum, gold, aluminum, cobalt nickel alloys, highly alloyed ferritic stainless steel containing molybdenum and chromium, and nickel-, chromium-, and molybdenum-containing alloys. The preferred current collector material is titanium. If CFₓ is the active material, the titanium cathode current collector has a thin layer of graphite/carbon paint applied thereto. Cathodes prepared as described above may be in the form of one or more plates operatively associated with at least one or more plates of anode material, or in the form of a strip wound with a corresponding strip of anode material in a structure similar to a “jellyroll”.

A preferred second formulation for a mixed metal oxide such as SVO or CSVO has, by weight, about 94% SVO and/or CSVO, 3% binder and 3% conductive diluent as the layer directly contacted to the current collector. Then, the first layer not contacting the current collector, but proximate the anode has a somewhat lesser percentage of SVO or CSVO. Alternately, the first layer not contacting the current collector, but proximate the anode has a somewhat greater percentage of SVO or CSVO.

In the case of a carbonaceous active material such as CFₓ, the second active formulation contacted to the current collector has, by weight, about 91% CFₓ, 5% binder, and 4% conductive diluent. Again, the first layer not contacting the current collector, but proximate the anode has a somewhat lesser percentage of the CFₓ material. Alternately, the first layer not contacting the current collector, but proximate the anode has a somewhat greater percentage of CFₓ.

Therefore, one exemplary cathode configuration is comprised of: a first cathode active material (100−x)%/a second cathode active material (100−y)%/current collector. Another configuration is comprised of: a first cathode active material (100−x)%/a second cathode active material (100−y)%/current collector/the second cathode active material (100−y)%/the first cathode active material (100−x)%. The first and second cathode active materials are the same. In either case, x and y are different and represent percentages of non-active materials and the non-active materials of the first and second formulations need not be the same. Preferably, x is greater than y. However, it is within the scope of the invention to have y being greater than x.

Specific examples of cathode configurations include:

silver vanadium oxide (100−x)%/silver vanadium oxide (100-y)%/current collector/silver vanadium oxide (100−y)%/silver vanadium oxide (100−x)%, wherein x and y represent non-active materials with x being greater than y;

about 94% silver vanadium oxide/greater than about 94% silver vanadium oxide/current collector/greater than about 94% silver vanadium oxide/about 94% silver vanadium oxide;

CFₓ (100−x)%/CFₓ (100−y)%/current collector/CFₓ (100−y)%/CFₓ (100−x)%, wherein x and y are different percentages of non-active materials; and

LiCoO₂ (100−x)%/LiCoO₂ (100−y)%/current collector/LiCoO₂ (100−y)%/LiCoO₂ (100−x)%, wherein x and y are different percentages of non-active materials.

In the representative case of SVO or CSVO, it might be useful to have the distinct layer contacting the current collector provided with a greater percentage of the active material than the layer spaced from the current collector, but facing the anode. As previously discussed in the Summary of the Invention section, this would help prevent vanadium dissolution into the electrolyte to reduce the consequential passivation build-up at the anode/electrolyte interpahse.

On the other hand, it may be useful to have a greater percentage of active material in the layer spaced from the current collector for the purpose of preventing a binder or conductive diluent material from dissolution into the electrolyte. For example, it is known that poly(alkylene) carbonates are soluble in an electrolyte containing propylene carbonate as a solvent component. By having a lesser percentage of poly(alkylene) carbonate and a greater percentage of active material facing the anode than is in the distinct layer contacting the current collector, the negative effects of this dissolution can be diminished.

In order to prevent internal short circuit conditions, the cathode is separated from the Group IA, IIA or IIIB anode by a suitable separator material. The separator is of electrically insulative material, and the separator material also is chemically unreactive with the anode and cathode active materials and both chemically unreactive with and insoluble in the electrolyte. In addition, the separator material has a degree of porosity sufficient to allow flow there through of the electrolyte during the electrochemical reaction of the cell. Illustrative separator materials include fabrics woven from fluoropolymeric fibers including polyvinylidine fluoride, polyethylenetetrafluoroethylene, and polyethylenechlorotrifluoroethylene used either alone or laminated with a fluoropolymeric microporous film, non-woven glass, polypropylene, polyethylene, glass fiber materials, ceramics, a polytetrafluoroethylene membrane commercially available under the designation ZITEX® (Chemplast Inc.), a polypropylene membrane commercially available under the designation CELGARD® (Celanese Plastic Company, Inc.), a membrane commercially available under the designation DEXIGLAS® (C.H. Dexter, Div., Dexter Corp.), and a membrane commercially available under the designation TONEN®.

The electrochemical cell of the present invention further includes a nonaqueous, ionically conductive electrolyte which serves as a medium for migration of ions between the anode and the cathode electrodes during the electrochemical reactions of the cell. The electrochemical reaction at the electrodes involves conversion of ions in atomic or molecular forms which migrate from the anode to the cathode. Thus, nonaqueous electrolytes suitable for the present invention are substantially inert to the anode and cathode materials, and they exhibit those physical properties necessary for ionic transport, namely, low viscosity, low surface tension and wettability.

A suitable electrolyte has an inorganic, ionically conductive salt dissolved in a nonaqueous solvent, and more preferably, the electrolyte includes an ionizable lithium salt dissolved in a mixture of aprotic organic solvents comprising a low viscosity solvent and a high permittivity solvent. The inorganic, ionically conductive salt serves as the vehicle for migration of the lithium ions to intercalate or react with the cathode active materials. Known lithium salts that are useful as a vehicle for transport of lithium ions from the anode to the cathode include LiPF₆, LiBF₄, LiAsF₆, LiSbF6, LiClO₄, LiO₂, LiAlCl₄, LiGaCl₄, LiC(SO₂CF₃)₃, LiN(SO₂CF₃)₂, LiSCN, LiO₃SCF₃, LiC₆F₅SO₃, LiO₂CCF₃, LiSO₆F, LiB(C₆H₅)₄, LiCF₃SO₃, and mixtures thereof.

Low viscosity solvents useful in formulating the electrolyte include esters, linear and cyclic ethers and dialkyl carbonates such as tetrahydrofuran, methyl acetate, diglyme, trigylme, tetragylme, dimethyl carbonate (DMC), 1,2-dimethoxyethane (DME), 1,2-diethoxyethane (DEE), 1-ethoxy,2-methoxyethane (EME), ethyl methyl carbonate (EMC), methyl propyl carbonate, ethyl propyl carbonate, diethyl carbonate (DEC), dipropyl carbonate, and mixtures thereof, and high permittivity solvents include cyclic carbonates, cyclic esters and cyclic amides such as propylene carbonate (PC), ethylene carbonate (EC), butylene carbonate, acetonitrile, dimethyl sulfoxide, dimethyl formamide, dimethyl acetamide, γ-valerolactone, γ-butyrolactone, N-methyl-pyrrolidinone, and mixtures thereof. In the present invention, the preferred electrolyte for a primary lithium cell is 0.8M to 1.5M LiAsF₆ or LiPF₆ dissolved in a 50:50 mixture, by volume, of propylene carbonate as the preferred high permittivity solvent and 1,2-dimethoxyethane as the preferred low viscosity solvent.

A preferred electrolyte for a secondary cell of an exemplary carbon/LiCoO₂ couple comprises a solvent mixture of EC:DMC:EMC:DEC. Most preferred volume percent ranges for the various carbonate solvents include EC in the range of about 20% to about 50%; DMC in the range of about 12% to about 75%; EMC in the range of about 5% to about 45%; and DEC in the range of about 3% to about 45%. In a preferred form, the electrolyte activating the cell is at equilibrium with respect to the ratio of DMC:EMC:DEC. This is important to maintain consistent and reliable cycling characteristics. It is known that due to the presence of low-potential (anode) materials in a charged cell, an un-equilibrated mixture of DMC:DEC in the presence of lithiated graphite (LiC₆≈0.01 V vs Li/Li⁺) results in a substantial amount of EMC being formed. When the concentrations of DMC, DEC and EMC change, the cell's cycling characteristics and temperature rating also change. Such unpredictability is unacceptable. This phenomenon is described in detail in U.S. Pat. No. 6,746,804 to Gan et al., which is assigned to the assignee of the present invention and incorporated herein by reference. Electrolytes containing the quaternary carbonate mixture of the present invention exhibit freezing points below −50° C., and lithium ion secondary cells activated with such mixtures have very good cycling behavior at room temperature as well as very good discharge and charge/discharge cycling behavior at temperatures below −40° C.

The assembly of the primary and secondary cells described herein is preferably in the form of a wound element configuration. That is, the fabricated negative electrode, positive electrode and separator are wound together in a “jellyroll” type configuration or “wound element cell stack” such that the negative electrode is on the outside of the roll to make electrical contact with the cell case in a case-negative configuration. Using suitable top and bottom insulators, the wound cell stack is inserted into a metallic case of a suitable size dimension. The metallic case may comprise materials such as stainless steel, mild steel, nickel-plated mild steel, titanium, tantalum or aluminum, but not limited thereto, so long as the metallic material is compatible for use with components of the cell.

The cell header comprises a metallic disc-shaped body with a first hole to accommodate a glass-to-metal seal/terminal pin feedthrough and a second hole for electrolyte filling. The glass used is of a corrosion resistant type having up to about 50% by weight silicon such as CABAL 12, TA 23, FUSITE 425 or FUSITE 435. The positive terminal pin feedthrough preferably comprises titanium although molybdenum, aluminum, nickel alloy, or stainless steel can also be used. The cell header is typically of a material similar to that of the case. The positive terminal pin supported in the glass-to-metal seal is, in turn, supported by the header, which is welded to the case containing the electrode stack. The cell is thereafter filled with the electrolyte solution described hereinabove and hermetically sealed such as by close-welding a stainless steel ball over the fill hole, but not limited thereto.

The above assembly describes a case-negative cell, which is the preferred construction of either the exemplary primary or secondary cell of the present invention. As is well known to those skilled in the art, the exemplary primary and secondary electrochemical systems of the present invention can also be constructed in case-positive configuration.

It is appreciated that various modifications to the inventive concepts described herein may be apparent to those of ordinary skill in the art without departing from the spirit and scope of the present invention as defined by the appended claims.

1. An electrochemical cell, which comprises:
a) a lithium anode;
b) a cathode of a configuration comprising: silver vanadium oxide (100−x) %/silver vanadium oxide (100−y) %/current collector/silver vanadium oxide (100−y) %/silver vanadium oxide (100−x) %,
i) wherein x and y represent percentages of non-active materials with x being greater than y, and
ii) wherein the non-active materials of the first and second formulations need not be the same; and
c) an electrolyte activating the anode and the cathode.

2.-6. (canceled)

7. The electrochemical cell of claim 1 wherein the cathode has a configuration comprised of: about 94% silver vanadium oxide/greater than about 94% silver vanadium oxide/current collector/greater than about 94% silver vanadium oxide/about 94% silver vanadium oxide.

8.-9. (canceled)

10. The electrochemical cell of claim 1 wherein the non-active materials are selected from a binder material and a conductive diluent.

11. The electrochemical cell of claim 10 wherein the binder is a powdered fluoro-polymer or a poly(alkylene carbonate) having the general formula R—O—C(═O)—O with R=C1 to C5.

12. The electrochemical cell of claim 10 wherein the conductive diluent is selected from the group consisting of acetylene black, carbon black, graphite, powdered nickel, powdered aluminum, powdered titanium, powdered stainless steel, and mixtures thereof.

13. The electrochemical cell of claim 1 wherein the current collector is selected from the group consisting of stainless steel, titanium, tantalum, platinum, gold, aluminum, cobalt nickel alloys, highly alloyed ferritic stainless steel containing molybdenum and chromium, and nickel-, chromium-, and molybdenum-containing alloys.

14. The electrochemical cell of claim 1 wherein the current collector is titanium having a coating selected from the group consisting of graphite/carbon material, iridium, iridium oxide and platinum provided thereon.

15. The electrochemical cell of claim 1 wherein the electrolyte includes at least one solvent selected from the group consisting of tetrahydrofuran, methyl acetate, diglyme, trigylme, tetragylme, dimethyl carbonate, 1,2-dimethoxyethane, 1,2-diethoxyethane, 1-ethoxy, 2-methoxyethane, ethyl methyl carbonate, methyl propyl carbonate, ethyl propyl carbonate, diethyl carbonate, dipropyl carbonate, propylene carbonate, ethylene carbonate, butylene carbonate, acetonitrile, dimethyl sulfoxide, dimethyl formamide, dimethyl acetamide, γ-valerolactone, γ-butyrolactone, N-methyl-pyrrolidinone, and mixtures thereof.

16. The electrochemical cell of claim 1 the electrolyte includes a lithium salt selected from the group consisting of LiPF₆, LiBF₄, LiAsF₆, LiSbF₆, LiClO₄, LiO₂, LiAlCl₄, LiGaCl₄, LiC(SO₂CF₃)₃, LiN(SO₂CF₃)₂, LiSCN, LiO₃SCF₃, LiC₆F₅SO₃, LiO₂CCF₃, LiSO₆F, LiB(C₆H₅)₄, LiCF₃SO₃, and mixtures thereof.

17. (canceled)

18. An electrochemical cell, which comprises:
a) a lithium anode;
b) a cathode of a configuration comprised of: silver vanadium oxide (100−x) %/silver vanadium oxide (100−y) %/current collector, with the silver vanadium oxide (100−x) % formulation facing the anode,
i) wherein x and y represent percentages of non-active materials with x being greater than y, and
ii) wherein the non-active materials designated by x and y of the respective first and second formulations need not be the same; and
c) an electrolyte activating the anode and the cathode.

19.-24. (canceled)

25. The electrochemical cell of claim 18 wherein the cathode has a configuration comprised of: about 94% silver vanadium oxide/greater than about 94% silver vanadium oxide/current collector/greater than about 94% silver vanadium oxide/about 94% silver vanadium oxide.

26.-27. (canceled)

28. The electrochemical cell of claim 18 wherein the non-active materials are selected from a binder material and a conductive diluent.

29. The electrochemical cell of claim 28 wherein the binder is a powdered fluoro-polymer or a poly(alkylene carbonate) having the general formula R—O—C(═O)—O with R=C1 to C5.

30. The electrochemical cell of claim 28 wherein the conductive diluent is selected from the group consisting of acetylene black, carbon black, graphite, powdered nickel, powdered aluminum, powdered titanium, powdered stainless steel, and mixtures thereof.

31. The electrochemical cell of claim 18 wherein the current collector is selected from the group consisting of stainless steel, titanium, tantalum, platinum, gold, aluminum, cobalt nickel alloys, highly alloyed ferritic stainless steel containing molybdenum and chromium, and nickel-, chromium-, and molybdenum-containing alloys.

32. The electrochemical cell of claim 18 wherein the current collector is titanium having a coating selected from the group consisting of graphite/carbon material, iridium, iridium oxide and platinum provided thereon.

33. The electrochemical cell of claim 18 wherein the electrolyte includes at least one solvent selected from the group consisting of tetrahydrofuran, methyl acetate, diglyme, trigylme, tetragylme, dimethyl carbonate, 1,2-dimethoxyethane, 1,2-diethoxyethane, 1-ethoxy, 2-methoxyethane, ethyl methyl carbonate, methyl propyl carbonate, ethyl propyl carbonate, diethyl carbonate, dipropyl carbonate, propylene carbonate, ethylene carbonate, butylene carbonate, acetonitrile, dimethyl sulfoxide, dimethyl formamide, dimethyl acetamide, γ-valerolactone, γ-butyrolactone, N-methyl-pyrrolidinone, and mixtures thereof.

34. The electrochemical cell of claim 18 the electrolyte includes a lithium salt selected from the group consisting of LiPF₆, LiBF₄, LiAsF₆, LiSbF₆, LiClO₄, LiO₂, LiAlCl₄, LiGaCl₄, LiC(SO₂CF₃)₃, LiN(SO₂CF₃)₂, LiSCN, LiO₃SCF₃, LiC₆F₅SO₃, LiO₂CCF₃, LiSO₆F, LiB(C₆H₅)₄, LiCF₃SO₃, and mixtures thereof.
